(19) United States
(12) Patent Application Publication
(10) Pub. No.: US 2014/0015210 A1
(43) Pub. Date: Jan. 16, 2014

(54) SHEET MATERIAL MOBILITY DEVICE

(71) Applicant: Mark E. Pasek, Estero, FL (US)

(72) Inventor: Mark E. Pasek, Estero, FL (US)

(21) Appl. No.: 13/449,868

(22) Filed: Apr. 18, 2012

Related U.S. Application Data
(60) Provisional application No. 61/517,382, filed on Apr. 20, 2011.

(51) Int. Cl. B62B 3/10

(52) U.S. Cl. CPC B62B 3/108
USPC 280/79.7

(57) ABSTRACT

The invention comprises a rolling device that allows one person to easily transport sheet material goods commonly used in construction and remodeling. While there are carts now used for this purpose they are usually wide and unstable. This device is very narrow and is designed to transport one or two sheets of material at a time. Another feature of the cart is that it uses large wheels and tires which allows ease of travel over irregular surfaces as found on many construction sites. The wheels are mounted in a fashion that allows the material to be carried below the center of gravity which greatly enhances the stability of the load. The handles are easily removed so this device can easily be transported in even the smallest of cars. This cart solves the problem of handling large, heavy, cumbersome sheets of construction material.

Priority and benefit of earlier date of Provisional Application Ser. No. 61/517,382 filed Apr. 20, 2011 is claimed.

### BACKGROUND OF THE INVENTION

The invention comprises a narrow rolling device that allows one person to easily transport sheet material goods commonly used in construction and remodeling. The inline cart holds the material in the device below the center of gravity which makes it very stable and easy to load. The device is narrow enough to move thru studded walls and around obstacles commonly found at construction sites. The large wheels and tires permit it to travel over irregular surfaces, gravel, and grass. The removable handles allow the device to be easily transported or stored when not in use.

### BRIEF DESRIPTION OF THE DRAWINGS

FIG. 1 shows the device as it carries a 4×8 sheet of drywall. Item 1 is a welded steel frame. Item 2 shows the two removable handles. Item 3 denotes the two large wheels/tires, please note that the wheels are mounted in a fashion to lower the center of gravity to improve stability. Item 4 depicts a 4×8 sheet of material such as drywall or plywood.

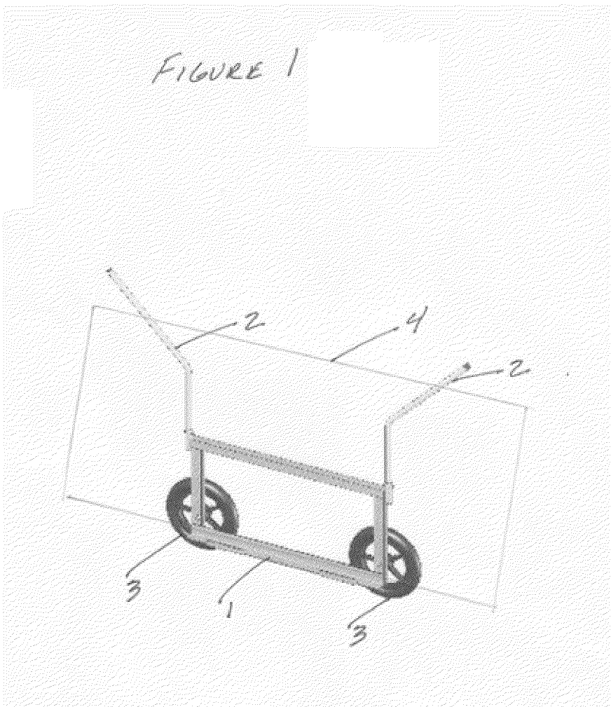

FIG. 2 shows the device from a side view. Item 1 is the welded steel frame. Item 2 shows one of the two removable handles. Item 3 shows one of the two large wheels/tires, please note it is mounted in a fashion to lower the center of gravity. Item 4 shows two sheets of 4×8 material. Please note the device is slightly tilted to transport the material.

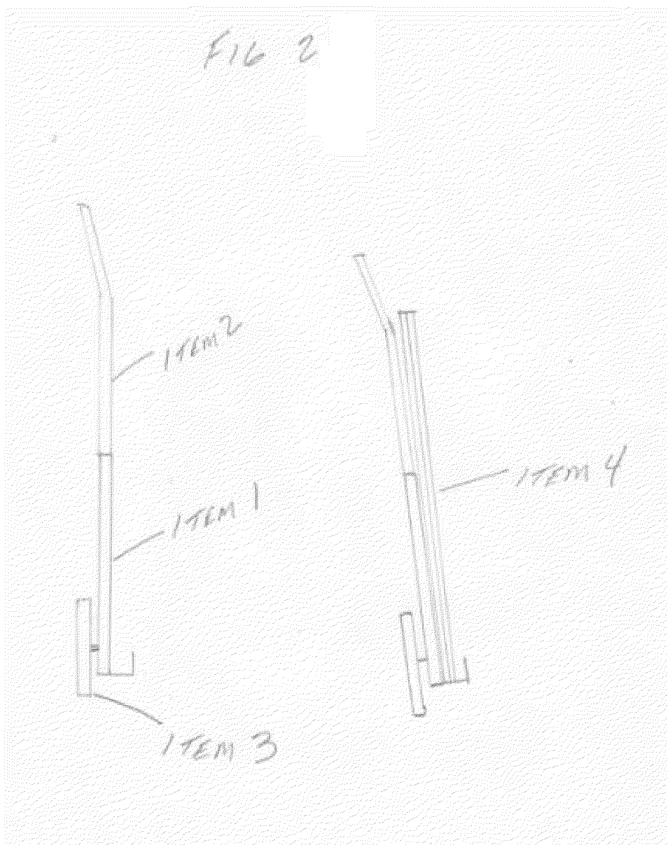

What is claimed is:

1. The narrow inline cart is designed to transport a small amount of sheet material and eliminate the current practice of lifting and carrying the material by hand.

2. The inline cart of claim 1 has two large wheels mounted at either end of said cart. These wheels are mounted in such a fashion as to insure the weight of the material transported is below the center of gravity.

3. The two handles of the inline cart of claim 1 are removable so when detached the inline cart can easily be transported in any motor vehicle.
